(19) United States
(12) Patent Application Publication
(10) Pub. No.: US 2014/0310076 A1
(43) Pub. Date: Oct. 16, 2014

(54) APPENDING ADVERTISING TO PERISHABLE VALIDATION TOKENS

(71) Applicants: Michael A. Liberty, Windermere, FL (US); Steven Bacastow, Cumming, GA (US)

(72) Inventors: Michael A. Liberty, Windermere, FL (US); Steven Bacastow, Cumming, GA (US)

(21) Appl. No.: 14/251,270

(22) Filed: Apr. 11, 2014

Related U.S. Application Data
(60) Provisional application No. 61/811,598, filed on Apr. 12, 2013.

(51) Int. Cl. G06Q 30/02

(52) U.S. Cl. CPC G06Q 30/0269
USPC 705/14.1; 705/14.49; 705/14.66

(57) ABSTRACT

Embodiments are directed to implementing targeted advertising in financial transactions. In one scenario, a computer system receives an indication that a mobile wallet user has initiated a financial transaction. The indication includes identification information that identifies the mobile wallet user. The computer system next identifies the mobile wallet user using the received identification information and generates a validation token for validating the financial transaction initiated by the mobile wallet user. The validation token includes at least one targeted advertisement for the mobile wallet user. The computer system then sends the validation token that includes the targeted advertisement to the mobile wallet user.

### CROSS-REFERENCE TO RELATED APPLICATIONS

This application claims priority to and the benefit of U.S. Provisional Application Ser. No. 61/811,598, entitled “Appending Advertising to Perishable Validation Tokens”, filed on Apr. 12, 2013, which application is incorporated by reference herein in its entirety.

### BACKGROUND

Computers have become highly integrated in the workforce, in the home, in mobile devices, and many other places. Computers can process massive amounts of information quickly and efficiently. Software applications designed to run on computer systems allow users to perform a wide variety of functions including business applications, schoolwork, entertainment and more. Software applications are often designed to perform specific tasks, such as word processor applications for drafting documents, or email programs for sending, receiving and organizing email.

Today's smart phones use software applications to perform a wide variety of functionality. In some cases, this functionality may include the ability to pay for items using a mobile payment system. Such a mobile payment system may allow users to pay for items at a store or over the internet using their phone.

### BRIEF SUMMARY

Embodiments described herein are directed to implementing targeted advertising in financial transactions. In one embodiment, a computer system receives an indication that a mobile wallet user has initiated a financial transaction. The indication includes identification information that identifies the mobile wallet user. The computer system next identifies the mobile wallet user using the received identification information and generates a validation token for validating the financial transaction initiated by the mobile wallet user. The validation token includes at least one targeted advertisement for the mobile wallet user. The computer system then sends the validation token that includes the targeted advertisement to the mobile wallet user.

In another embodiment, a computer system sends an indication that a mobile wallet user has initiated a financial transaction, where the indication includes identification information for the mobile wallet user. The computer system receives a validation token that is to be used to validate the financial transaction initiated by the mobile wallet user. The validation token includes at least one targeted advertisement for the mobile wallet user, where the advertisement is targeted to the mobile wallet user based on demographic information associated with the mobile wallet user. The computer system also implements the validation token to validate the financial transaction.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates a computer architecture in which embodiments described herein may operate including implementing targeted advertising in financial transactions.

FIG. 2 illustrates an embodiment of a validation token that includes a targeted advertisement.

FIG. 3 illustrates an embodiment of an electronic financial transaction receipt that includes a targeted advertisement.

FIG. 4 illustrates a flowchart of an example method for implementing targeted advertising in financial transactions.

FIG. 5 illustrates a flowchart of an alternative example method for implementing targeted advertising in financial transactions.

FIG. 6 illustrates an embodiment of an advertisement appending rule database.

### DETAILED DESCRIPTION

Embodiments described herein are directed to implementing targeted advertising in financial transactions. In one embodiment, a computer system receives an indication that a mobile wallet user has initiated a financial transaction. The indication includes identification information that identifies the mobile wallet user. The computer system next identifies the mobile wallet user using the received identification information and generates a validation token for validating the financial transaction initiated by the mobile wallet user. The validation token includes at least one targeted advertisement for the mobile wallet user. The computer system then sends the validation token that includes the targeted advertisement to the mobile wallet user.

In another embodiment, a computer system sends an indication that a mobile wallet user has initiated a financial transaction, where the indication includes identification information for the mobile wallet user. The computer system receives a validation token that is to be used to validate the financial transaction initiated by the mobile wallet user. The validation token includes at least one targeted advertisement for the mobile wallet user, where the advertisement is targeted to the mobile wallet user based on demographic information associated with the mobile wallet user. The computer system also implements the validation token to validate the financial transaction.

In yet another embodiment, a financial transaction processing system is provided. The financial transaction processing system receives an indication that a mobile wallet user has initiated a financial transaction. The indication includes transaction information including the mobile wallet user's phone number and personal identification number (PIN) or biometric factor, along with one or more portions of demographic information. The financial transaction processing system then identifies the mobile wallet user using the received phone number and PIN or biometric factor. Once the user has been identified, the validation token generating module of the financial transaction processing system generates a perishable, encrypted validation token for validating the financial transaction initiated by the mobile wallet user. The perishable, encrypted validation token includes at least one targeted advertisement that is targeted to the mobile wallet user. This perishable, encrypted validation token, including the appended targeted advertisement, is then sent to the mobile wallet user where it is used to validate the initiated financial transaction.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments described herein may comprise or utilize a special purpose or general-purpose computer including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computer system. Computer-readable media that store computer-executable instructions in the form of data are computer storage media. Computer-readable media that carry computer-executable instructions are transmission media. Thus, by way of example, and not limitation, embodiments described herein can comprise at least two distinctly different kinds of computer-readable media: computer storage media and transmission media.

Computer storage media includes RAM, ROM, EEPROM, CD-ROM, solid state drives (SSDs) that are based on RAM, Flash memory, phase-change memory (PCM), or other types of memory, or other optical disk storage, magnetic disk storage or other magnetic storage devices, or any other medium which can be used to store desired program code means in the form of computer-executable instructions, data or data structures and which can be accessed by a general purpose or special purpose computer.

A “network” is defined as one or more data links and/or data switches that enable the transport of electronic data between computer systems and/or modules and/or other electronic devices. When information is transferred or provided over a network (either hardwired, wireless, or a combination of hardwired or wireless) to a computer, the computer properly views the connection as a transmission medium. Transmission media can include a network which can be used to carry data or desired program code means in the form of computer-executable instructions or in the form of data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”), and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that various embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. Embodiments described herein may also be practiced in distributed system environments where local and remote computer systems that are linked (either by hardwired data links, wireless data links, or by a combination of hardwired and wireless data links) through a network, each perform tasks (e.g. cloud computing, cloud services and the like). In a distributed system environment, program modules may be located in both local and remote memory storage devices.

In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

For instance, cloud computing is currently employed in the marketplace so as to offer ubiquitous and convenient on-demand access to the shared pool of configurable computing resources. Furthermore, the shared pool of configurable computing resources can be rapidly provisioned via virtualization and released with low management effort or service provider interaction, and then scaled accordingly.

A cloud computing model can be composed of various characteristics such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth. In this description and in the claims, a “cloud computing environment” is an environment in which cloud computing is employed.

Additionally or alternatively, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), and other types of programmable hardware.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

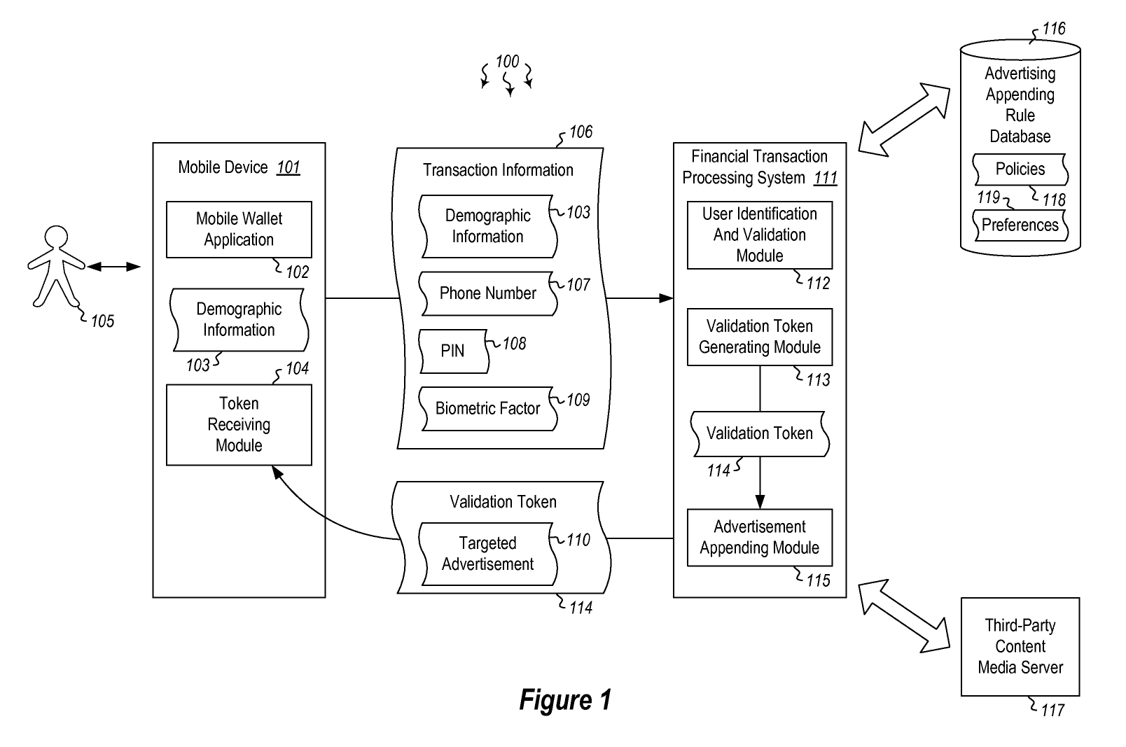

FIG. 1 illustrates a computer architecture 100 in which at least one embodiment may be employed. Computer architecture 100 includes mobile device 101. Mobile device 101 may be any type of computer system, including a cellular phone, tablet, laptop, gaming device, wearable device or other mobile computing system. The mobile device includes modules for performing different types of functionality. For instance, mobile device 101 may include a mobile wallet application 102. The mobile wallet application may provide many different functions, including the ability to pay for goods and services using the mobile device. The mobile wallet may be linked to various credit and/or debit accounts belonging to the user 105. The mobile wallet application 102 may then facilitate initiation and completion of a financial transaction, in conjunction with a financial transaction processing system 111.

The financial transaction processing system 111 may be configured to receive transaction information 106 for one or more different financial transactions initiated by different native or third party mobile wallet applications. A native application may include, for example, an application provided by the device manufacturer or distributor (e.g. a mobile service provider). A third-party mobile wallet may include, for example, an application developed by or on behalf of a retailer such as a restaurant or grocery store or an entity such as a city government. In one example, user 105 may use mobile wallet application 102 on mobile device 101 to initiate a financial transaction at a retailer or other entity that allows items to be paid for using a mobile wallet.

The mobile wallet application 102 may send transaction information 106 including the user's name and other demographic information 103, bank and/or credit card information, the user's phone number 107 and the user's personal identification number (PIN) 108 and a biometric factor 109. The transaction information 106 may include other information used to process the transaction including the items or services being purchased, pricing information, tax information, date & time, geo-coordinates, merchant identifier (ID), zip code, transaction type (e.g. purchase, bill-payment, mobile top-up, peer-to-peer (P2P) payment, remittance), and other related items. The biometric factor 109 may include any type of biometric information that may be used to identify the mobile wallet user 105 including, but not limited to, a fingerprint scan, an iris scan, facial recognition, heartbeat detection, voice recognition or other biometric means of identifying a person.

The user identification and validation module 112 of the financial transaction processing system 111 may receive and process the transaction information. The user identification and validation module 112 may use the received demographic information 103, phone number 107 and/or PIN 108 and/or biometric factor 109 to identify the user 105 and verify the user's identity. In this way, the information required for user identification may vary with the type of transaction. For example, a P2P payment transaction may require a PIN. In another example, a purchase transaction in excess of an established purchase amount threshold may alternatively require a PIN and/or a biometric factor. The validation token generating module 113 may then generate a perishable, encrypted validation token 114 that is to be used by the user and/or the mobile wallet application 102 to complete the transaction. The validation token 114, as the term is used herein, may refer to a software, hardware or other security token that may be used to validate a transaction. In some embodiments, the validation token may be a perishable, encrypted software token that facilitates two-factor authentication. The validation token may be generated based on a shared secret or based on public key (i.e. asymmetric) cryptography. Regardless of how the perishable, encrypted validation token 114 is generated or which kind of token is used or generated, the token may be sent to the token receiving module 104 of the mobile device.

Before the validation token is sent, however, the advertisement appending module 115 in the financial transaction processing system 111 may append a targeted advertisement 110 to the validation token 114. The advertisement may be from substantially any producer or seller of goods or services. The appended advertisement may be shown to the user 105 when it is received by the token receiving module 104. Thus, when the user is using the mobile wallet to pay for an item, transfer money or perform some other financial transaction, the validation token 114 used to validate the transaction may include an advertisement from a company or other entity. The advertisement may be the same for a given period of time, or may change each transaction based on policies 118 (i.e. rules for distributing advertising) and preferences 119 (e.g. user or provider preferences) contained in advertisement appending rule database (116). The advertisement 110 may merely show a logo or picture advertising the company, or may be a link to a web site, a video, an animated gif, or any other type or combination of media content which may be hosted on a local, managed media server or on a third-party content media server (117).

The advertisement 110 may be targeted to the user 105 based on the demographic information 103 sent with the transaction information 106. The demographic information may be detailed or general in nature, depending on the transaction, the advertising company, agreements between the user 105 and the financial transaction processing system 111, or other configurations or policies. Thus, for example, the advertisement appending module 115 may look at the demographic information 103 for user 105 and determine that the user is a male between 18-34, is of Asian descent, is college educated and lives within five miles of the store at which the financial transaction is taking place. The advertisement appending module 115 may then append an advertisement that is targeted to his demographic. Similarly, the system 111 may determine in another example that the user is a female between the ages of 55-70 and has a yearly income of between $50-70,000. The advertisement appending module 115 may then append an advertisement that is targeted to her general demographic.

In this manner, producers and sellers of goods and services may market their items to users of a certain demographic. While two examples are given above, it will be appreciated that substantially any type of demographic information may be queried of the mobile device user and stored in the demographic information 103. Moreover, it will be appreciated that certain ads will be more applicable to certain groups of people, whether it be young males or females, mothers or fathers, the elderly, certain ethnicities, religious groups, education levels, income levels, location of residence, occupation or other demographics. Accordingly, a producer or seller may specify which advertisements are to be presented to which mobile wallet users.

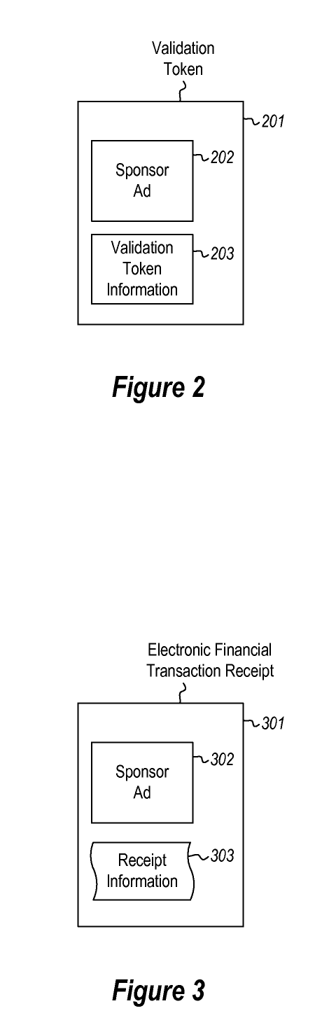

The ads may be further targeted based on the location where the financial transaction is taking place. For instance, if the user 105 initiates a transaction within a specified grocery store, the advertisement may be for goods or services provided by that grocery store. Similarly, the advertisement may be for goods or services provided by other retailers within a certain range of the store (e.g. other stores within a mall or shopping area). As shown in FIG. 2, the ads 202 may be placed in a prominent position above the validation token information 203 (e.g. based on policies 118 and/or user preferences 119 in the advertisement appending rule database 116). It will be understood that the ads may be placed above, below, on the sides or substantially anywhere within the validation token 201. As shown in FIG. 3, ads may also be placed in an electronic financial transaction receipt 301. Such receipts may be sent at the completion of the transaction, after the transaction has been validated using the token 201. The ad(s) 302 may be placed substantially anywhere on or within the receipt 301, including above, below, or to the side of the receipt information 303. These aspects will be further described in an example below.

In one embodiment, the financial transaction processing system 111 receives an indication that a mobile wallet user 105 has initiated a financial transaction. The indication includes transaction information 106 containing the mobile wallet user's phone number 107 and personal identification number (PIN) 108 and/or biometric factor 109, along with one or more portions of demographic information 103. The financial transaction processing system 111 then identifies the mobile wallet user using the received phone number and PIN and/or biometric factor 109. Once the user has been identified, the validation token generating module 113 of the financial transaction processing system 111 generates a perishable, encrypted validation token 114 for validating the financial transaction initiated by the mobile wallet user 105. The perishable, encrypted validation token (201 in FIG. 2) includes at least one targeted advertisement 110/202 that is targeted to the mobile wallet user. This perishable, encrypted validation token 201, including the appended targeted advertisement 202, is then sent to the mobile wallet user 105 where it is used to validate the initiated financial transaction.

As mentioned above, the demographic information associated with the mobile wallet user sent along with the transaction information 106 may be accessed by the financial transaction processing system 111. The demographic information 103 is used to target the advertisement to the mobile wallet user 105. Retailers and producers that create the advertisements and want to disseminate the advertisements may be provided with at least a portion of the user's demographic information. In some cases, the information may be quite limited, while in other cases, a larger amount of demographic information may be provided. The advertisement may be for goods or services that would likely interest the user, or may be for goods or services provided within a close radius of the user's current location. For example, if the user is at a retail store buying goods, the targeted advertisement may be for a local restaurant that is in the retail store's vicinity. Many other such embodiments are possible, including providing advertising for certain types of stores, certain types of services, stores within a specified driving or walking distance, stores that are currently open (e.g. if the transaction is being performed late at night), stores that cater to that user's demographic, or other scenarios.

In some cases, if the financial transaction is initiated within a specified store, the targeted advertisement may be valid for items sold by the specified store (or group of stores, or stores owned by the same owner). The targeted advertisement may include an offer that expires after a specified period of time, or is only valid on certain days or at certain times. In some cases, the retailer or goods producer that is paying for the advertisement may receive an indication that the targeted advertisement was viewed by the mobile wallet user, thereby establishing that the ad reached the user. After the financial transaction has been processed, an electronic transaction receipt (e.g. 301 in FIG. 3) is provided to the user and to the merchant. The electronic transaction receipt may be provided via the user's mobile wallet 102 and, in addition to any advertisements on the validation token, may itself include a targeted ad 302 for the mobile wallet user. In this manner, producers or sellers of goods and services may be able to advertise to target audiences via perishable validation tokens and/or electronic transaction receipts.

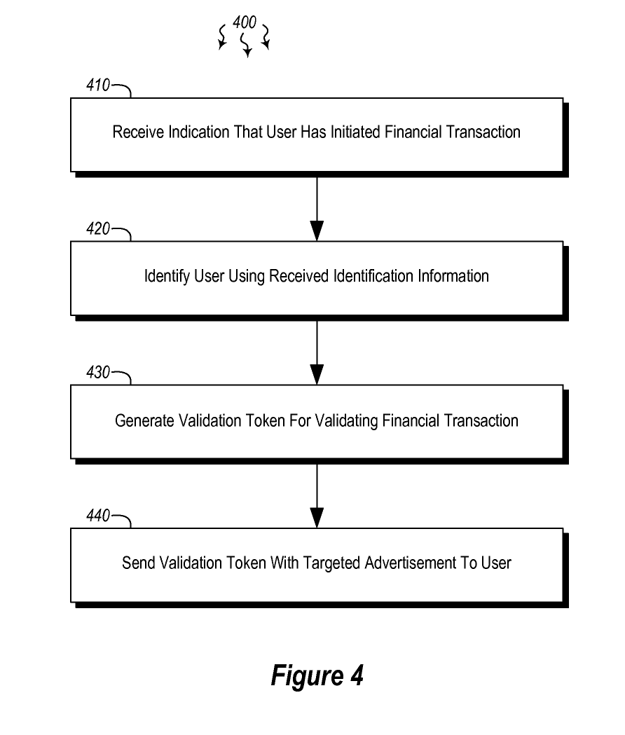

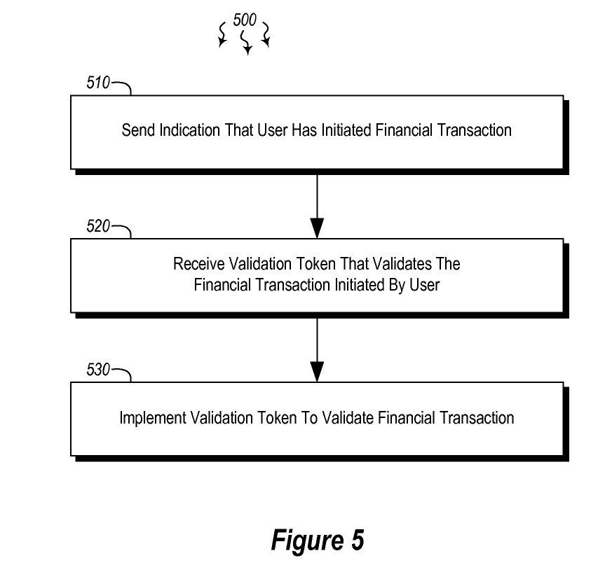

Still further, when viewed from the mobile wallet user's perspective, the user may send an indication that they have initiated a financial transaction. The indication may include the user's phone number 107 and personal identification number (PIN) 108 and/or biometric factor 109, along with various portions of demographic information 103. The user's mobile device 101 may then receive a perishable, encrypted validation token 114 that is to be used to validate the financial transaction initiated by the user 105. That perishable, encrypted validation token may include at least one targeted advertisement 110 for the mobile wallet user 105. That validation token may then be implemented to validate the financial transaction. As such, when viewed from the user's perspective, the user may see that a given company has sponsored their validation token, or is simply advertising their product to that user in a targeted fashion. These concepts will be explained further below with regard to methods 400 and 500 of FIGS. 4 and 5, respectively.

In view of the systems and architectures described above, methodologies that may be implemented in accordance with the disclosed subject matter will be better appreciated with reference to the flow charts of FIGS. 4 and 5. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 4 illustrates a flowchart of a method 400 for implementing targeted advertising in financial transactions. The method 400 will now be described with frequent reference to the components and data of environment 100.

Method 400 includes receiving an indication that a mobile wallet user has initiated a financial transaction, the indication including one or more portions of identification information for the mobile wallet user (410). For example, financial transaction processing system 111 may receive transaction information 106 from user 105. The transaction information 106 may include identification information such as demographic information 103, a phone number 107 and/or a personal identification number (PIN) 108. Any or all of this information may be used to identify the user 105 and further identify specific traits about the user that may be available in the demographic information 103.

As mentioned above, the demographic information may be information about that user's age, ethnicity, education level, occupation, income level, interests, religion, etc. The user may be able to specify which portions of demographic information 103 are shared with different companies or other third parties. For instance, a user may wish to share more demographic information with certain companies to receive targeted offers or discounts on products they purchase routinely, and may wish to share less demographic information with other entities with which they are less familiar. Accordingly, users may specify which information is shared or which types of information is shared with other entities.

Method 400 next includes identifying the mobile wallet user using the received identification information (420). The user identification and validation module 112 of the financial transaction processing system 111 may be used to identify the mobile wallet user 105 and further validate their identity. Once the user has been identified and/or validated, the validation token generating module 113 may generate a validation token 114 for validating the financial transaction initiated by the mobile wallet user 105, where the validation token includes at least one targeted advertisement 110 for the mobile wallet user (430). The financial transaction processing system 111 may then send the validation token that includes the targeted advertisement to the mobile wallet user (440).

In some embodiments, the validation token is perishable and/or encrypted. If the validation token is perishable, then it is only valid for a specified amount of time. After that amount of time has expired, or after a certain date and time has been reached, that perishable validation token may no longer be used to validate a financial transaction. If the validation token 114 is encrypted, then it is only accessible by those having the rights (e.g. the proper decryption key) to decrypt the token. Thus, if the validation token 114 sent from the financial transaction processing system 111 is encrypted as a result of the user's initiation of a transaction, the validation token will only be decryptable by that user. Any encryption algorithm or standard may be used to encrypt and decrypt the validation token.

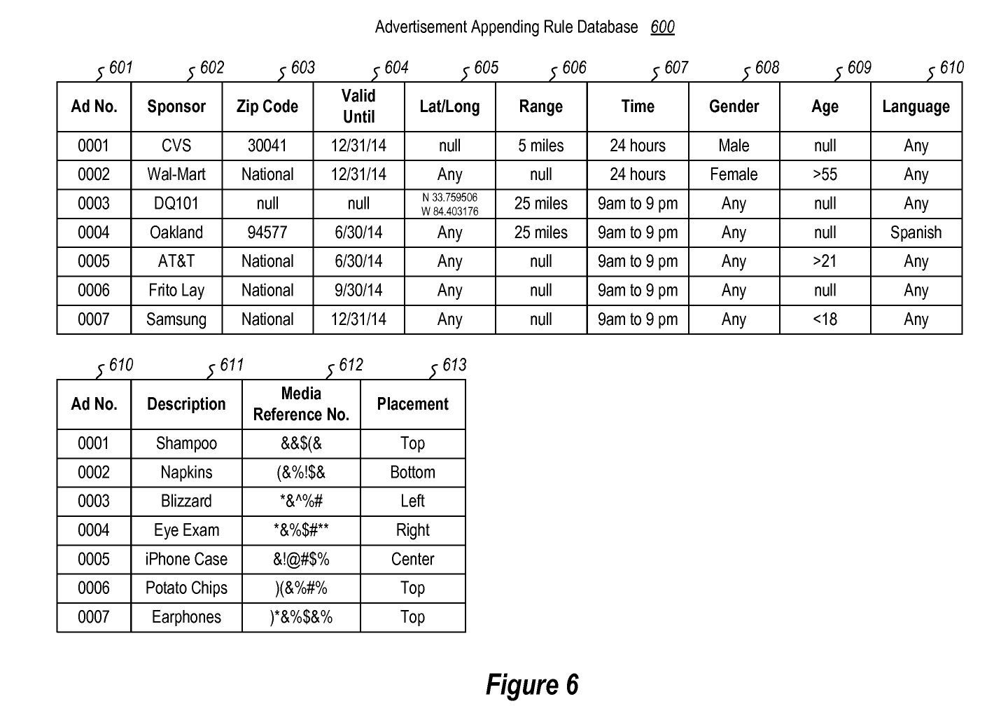

The financial transaction processing system 111 may be configured to communicate with other servers or databases. For example, the financial transaction processing system 111 may communicate with the advertisement appending rule database 116 which includes policies 118 and/or preferences 119. These preferences may include the user's preferences dictating which demographic information is to be provided to which providers. The policies 118 may include various rules for distributing targeted ads to users (in some cases, only to those users that have opted-in to receive such targeted ads). The policies may dictate that certain ads are shown to certain users according to their demographic information. Thus, the financial transaction processing system 111 may access these policies to determine how ads are to be distributed among mobile wallet users. Examples of such policies are shown in FIG. 6.

In one embodiment, the advertisement appending rule database 116 stores policies in the form of database tables. The database table 600 contains information about various ads and when they are to be distributed to mobile wallet users. The information may include the Ad Number (601), Sponsor (602), Zip Code (603), Valid Until (604), Latitude & Longitude (605), Range (606), Time (607), Gender (608), Age (609), Language (610) and/or other attributes. Each provider of goods or services (i.e. the entities paying for the ads) may be able to choose specifically whom they intend to target with their ads and how those ads are to be displayed.

As shown in FIG. 6, Ad 0001 is a shampoo offer sponsored by CVS stores in Zip Code 30041 and is valid until Dec. 31, 2014. Latitude and longitude are not relevant (or at least are not specified) for this offer. The offer can be sent to mobile wallet users if the users are within 5 miles of the store zip code. The ad can be used 24 hours per day, and is geared towards male customers of any age and language. In contrast, in another example, Ad 0004 is sponsored by the City of Oakland, and is valid until Jun. 30, 2014. This is an offer for Spanish-speaking users for a free Eye Exam. Ad 0003 is sponsored by a Dairy Queen franchise owner (DQ101) and is valid within 25 miles of a specific latitude and longitude.

Policies for a given ad may also include a description of the ad 611 (e.g. an ad for shampoo or for a free eye exam), an encrypted media reference number 612 and an indication of ad placement 613. The preferred placement for the CVS shampoo ad (Ad 0001) is at the top of the display. The preferred placement for the iPhone Case (Ad 0005) is in the Center of the display. The encrypted media reference number is related to each offer, and may include an embedded link to advertisement content stored in a different location (e.g. on third-party content media server 117). Thus, the policy may dictate many different settings for a targeted advertisement, including when it is to be distributed, to whom it is to be distributed, how it is to appear when displayed, when it is valid until and where to download the ad content from.

Thus, ad producers may specify which ads are sent to which users based on their location, their demographics, the time of the day, or based on other factors not shown. It will be apparent to one skilled in the art that many different rules may be applied to determine which ads are to be distributed to which mobile wallet users. These rules and policies may be dynamically updated and expanded according to the desires of the ad producers. Thus, if a specified store is an ad producer, that ad producer may specify that the offer, coupon, discount or other item described in the targeted ad is only valid within a specified store, and possibly only for items sold at that specified store. Similarly, if the user is currently at a mall or other shopping area, stores within that mall or shopping area may all benefit from targeted ads that are usable in stores located in that mall or shopping area. In some cases, ad providers may indicate that a specific ad is only valid within a specified geofence (i.e. within a set of latitude and longitude coordinates), or may specify that a specific ad is only to be sent to users that are located within a specific geofence. This may allow advertisers to reach people attending a concert or movie, etc.

After an ad has been distributed, the financial transaction processing system 111 may receive an indication that the targeted advertisement was viewed by the mobile wallet user and may receive a further indication when a given offer or discount is applied by the user in a purchase. This viewership and/or actual-use information may be sent to the provider of the ad to let the provider know about the effectiveness of their ad. When a mobile wallet user has completed a mobile wallet transaction, the financial transaction processing system 111 may send an electronic transaction receipt to the user.

As shown in FIG. 3, the electronic transaction receipt 301 may include its own targeted ad 302 as well as the corresponding receipt information 303 for the purchase. Targeted ads may be provided on electronic financial transaction receipts in addition to or as an alternative to the targeted ads provided on the validation token. The ads on the electronic receipts may be different than or the same as those provided on validation tokens, and may be triggered by the same or a different set of policies. This electronic transaction receipt 301 may be provided to the user's mobile wallet application 102, or may be physically printed and given to the user. Thus, in this manner, advertisers may reach users in a targeted and direct manner, and may provide the offers on validation tokens or on transaction receipts. Any offers or discounts provided in the ad may be stored on the user's mobile wallet application, and may later be automatically applied to the corresponding goods or services when purchased using the mobile wallet.

FIG. 5 illustrates a flowchart of a method 500 for {what the method does}. The method 500 will now be described with frequent reference to the components and data of environment 100. In some cases, the method 500 may be executed as part of a computer program product that comprises one or more computer-readable storage media having stored thereon computer-executable instructions that, when executed by one or more processors of a computing system, cause the computing system to perform the method.

Method 500 includes sending an indication that a mobile wallet user has initiated a financial transaction, the indication including identification information for the mobile wallet user (510). For example, mobile device 101 may send transaction information 106 to financial transaction processing system 111, indicating that user 105 has initiated a financial transaction. Method 500 further includes receiving a validation token 114 that is to be used to validate the financial transaction initiated by the mobile wallet user 105 (520). The validation token includes at least one targeted advertisement 110 for the mobile wallet user, where the advertisement is targeted to the mobile wallet user based on demographic information associated with the mobile wallet user 105. This validation token may then be implemented to validate the user's financial transaction (530).

The user may be able to validate the transaction using the validation token 114 and some combination personal information such as the user's phone number and/or a PIN and/or a biometric factor. The targeted advertisement may be valid for at least one item sold by a specified store and may only be valid for a very limited amount of time (e.g. in the next 15 minutes). The targeted advertisement may include a coupon, discount, buy-one-get-one-free offer or other type of offer. This offer or discount may be applied automatically to the item the user is purchasing using their mobile wallet. As mentioned above, the targeted advertisements may be distributed to mobile wallet users according to a specified advertisement appending rule policy 118. This policy may be updated by advertisers over time as they attempt to target and provide ads to specific demographics. The advertisement appending rule policies are thus dynamically changeable and configurable by the advertisers. Moreover, users may provide their own preferences 119 indicating which offers or types of offers they are open to receiving, and/or which advertisers they are willing to receive advertisements from. In this manner, mobile wallet users may use their phones to make purchases and, during the course of those purchases, may receive ads for items and may use any offers or discounts provided in the ads in their purchases.

Accordingly, methods, systems and computer program products are provided which implement targeted advertising in financial transactions. It should be understood that the financial transactions references above may be compliant with any of a plurality of country-specific regulations including at least Know Your Customer (KYC) regulations, the PATRIOT Act and the Payment Card Industry Data Security Standard (PCI-DSS).

The concepts and features described herein may be embodied in other specific forms without departing from their spirit or descriptive characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

We claim:

1. A computer system comprising the following:
one or more processors;
system memory;
one or more computer-readable storage media having stored thereon computer-executable instructions that, when executed by the one or more processors, causes the computing system to perform a method for implementing targeted advertising in financial transactions, the method comprising the following:
receiving an indication that a mobile wallet user has initiated a financial transaction, the indication including one or more portions of identification information for the mobile wallet user;
identifying the mobile wallet user using the received identification information;
generating a validation token for validating the financial transaction initiated by the mobile wallet user, the validation token including at least one targeted advertisement for the mobile wallet user; and
sending the validation token that includes the at least one targeted advertisement to the mobile wallet user.

2. The computer system of claim 1, wherein the validation token comprises a perishable, encrypted validation token.

3. The computer system of claim 2, further comprising accessing one or more portions of demographic information associated with the mobile wallet user, the demographic information being implemented to target the advertisement to the mobile wallet user.

4. The computer system of claim 3, wherein a producer of the at least one targeted advertisement is provided with at least a portion of the mobile wallet user's demographic information.

5. The computer system of claim 4, wherein the targeted advertisement is sent to those mobile wallet users that fit a specified demographic according to the mobile wallet user's demographic information.

6. The computer system of claim 3, wherein the financial transaction is initiated within a specified store, and wherein the targeted advertisement is valid for items sold by the specified store.

7. The computer system of claim 3, wherein the financial transaction is initiated within a specified store, and wherein the targeted advertisement is valid for items sold by retailers within a specified distance of the specified store.

8. The computer system of claim 1, further comprising receiving an indication that the targeted advertisement was viewed by the mobile wallet user.

9. The computer system of claim 1, wherein, upon completion of the financial transaction, an electronic transaction receipt is provided to the user.

10. The computer system of claim 9, wherein the electronic transaction receipt is provided to the user's mobile wallet.

11. The computer system of claim 10, wherein the electronic transaction receipt includes a targeted advertisement for the mobile wallet user.

12. The computer system of claim 1, wherein the identification information comprises at least one of the mobile wallet user's phone number or a personal identification number (PIN).

13. A computer program product for implementing a method for implementing targeted advertising in financial transactions, the computer program product comprising one or more computer-readable storage media having stored thereon computer-executable instructions that, when executed by one or more processors of a computing system, cause the computing system to perform the method, the method comprising:
sending an indication that a mobile wallet user has initiated a financial transaction, the indication including identification information for the mobile wallet user;
receiving a validation token that is to be used to validate the financial transaction initiated by the mobile wallet user, the validation token including at least one targeted advertisement for the mobile wallet user, the advertisement being targeted to the mobile wallet user based on demographic information associated with the mobile wallet user; and
implementing the validation token to validate the financial transaction.

14. The computer program product of claim of claim 13, wherein the identification information for the mobile wallet user comprises the mobile wallet user's phone number and one of a personal identification number (PIN) or a biometric factor.

15. The computer program product of claim 13, wherein the targeted advertisement is valid for at least one item sold by a specified store.

16. The computer program product of claim 15, wherein the targeted advertisement includes a coupon or discount at the specified store, and wherein the coupon or discount is applied automatically to the at least one item at the specified store.

17. The computer program product of claim 13, wherein the targeted advertisement is valid for at stores located within a specified geofence.

18. At a computer system including at least one processor and a memory, a computer-implemented method for implementing targeted advertising in compliant financial transactions, the method comprising:
receiving an indication that a mobile wallet user has initiated a financial transaction, the indication including one or more portions of identification information for the mobile wallet user;
identifying the mobile wallet user using the received identification information;
generating a validation token for validating the financial transaction initiated by the mobile wallet user, the validation token including at least one targeted advertisement for the mobile wallet user; and
sending the validation token that includes the at least one targeted advertisement to the mobile wallet user.

19. The method of claim 18, wherein the targeted advertisements are distributed to mobile wallet users according to a specified advertisement appending rule policy.

20. The method of claim 18, wherein the advertisement appending rule policy is dynamically changeable and configurable by a user.

21. The method of claim 18, wherein the targeted advertisement is rendered using a media reference stored in a rule database.

22. The method of claim 21, wherein the media reference number includes an embedded link to advertisement content stored on a third-party content media server.
